(19) United States
(12) Patent Application Publication
(10) Pub. No.: US 2014/0238027 A1
(43) Pub. Date: Aug. 28, 2014

(54) THERMALLY COMPLIANT DUAL WALL LINER FOR A GAS TURBINE ENGINE

(71) Applicant: United Technologies Corporation, (US)

(72) Inventor: Donald W. Peters, Colchester, CT (US)

(73) Assignee: UNITED TECHNOLOGIES CORPORATION, Hartford, CT (US)

(21) Appl. No.: 13/725,114

(22) Filed: Dec. 21, 2012

(51) Int. Cl. F02C 7/24

(52) U.S. Cl. CPC F02C 7/24
USPC 60/752

(57) ABSTRACT

A stiffener for a liner assembly of a gas turbine engine includes a second resilient member arranged on a first resilient member at substantially ninety (90) degree orientation.

### BACKGROUND

The present disclosure relates to gas turbine engines, and more particularly to an exhaust duct therefor.

Gas turbine engines, such as those which power modern military aircraft, include a compressor to pressurize a supply of air, a combustor to burn a hydrocarbon fuel in the presence of the pressurized air, and a turbine to extract energy from the resultant combustion gases and generate thrust. Downstream of the turbine, an augmentor, or “afterburner”, is operable to selectively increase the thrust. The increase in thrust is produced when oxygen contained within the exhaust gases of the engine downstream of the turbine is injected with fuel and burned to generate a second combustion.

Due in part to the harsh environment of the second combustion, a liner assembly is disposed between the exhaust gas and the exhaust duct. These may be of single or double walled construction, with a hot sheet and a cold sheet. Cooling air typically extracted from the compressor is flowed between the liner assembly and exhaust duct then discharged through the liner assembly.

The attachment of the hot sheet and the cold sheet is typically accomplished with Z-resilient member stiffeners. Although effective, transverse thermal gradient in which the difference in temperature between the hot and cold sheets may develop stress in the Z-resilient members. Also, each Z-resilient member may require unique and relatively expensive manufacturing tooling.

### SUMMARY

A stiffener for a liner assembly of a gas turbine engine according to one disclosed non-limiting embodiment of the present disclosure includes a first resilient member; and a second resilient member arranged on said first resilient member at a substantially ninety (90) degree orientation.

In a further embodiment of the foregoing embodiment, the first resilient member and said second resilient member are formed from a single cross-section-shaped piece.

In a further embodiment of any of the foregoing embodiments, the first resilient member and said second resilient member are generally racetrack shaped.

In a further embodiment of any of the foregoing embodiments, the first resilient member and said second resilient member are generally oval.

In a further embodiment of any of the foregoing embodiments, the first resilient member and said second resilient member are generally circular.

A liner assembly for a gas turbine engine according to another disclosed non-limiting embodiment of the present disclosure includes a cold sheet, a hot sheet, and a multiple of stiffeners between said cold sheet and said hot sheet, at least one of said multiple of stiffeners includes a first resilient member arranged on a second resilient member.

In a further embodiment of the foregoing embodiment, the first resilient member and said second resilient member are oriented at a substantially ninety (90) degrees.

In a further embodiment of any of the foregoing embodiments, the cold sheet is corrugated.

In a further embodiment of any of the foregoing embodiments, the hot sheet and said cold sheet are axisymmetric in cross-section.

In a further embodiment of any of the foregoing embodiments, the hot sheet and said cold sheet are non-axisymmetric in cross-section.

In a further embodiment of any of the foregoing embodiments, the hot sheet and said cold sheet are oval in cross-section.

In a further embodiment of any of the foregoing embodiments, the hot sheet and said cold sheet are rectilinear in cross-section.

In a further embodiment of any of the foregoing embodiments, the hot sheet and said cold sheet define a serpentine duct.

In a further embodiment of any of the foregoing embodiments, the hot sheet and said cold sheet terminate in a nozzle with a convergent-divergent nozzle.

In a further embodiment of any of the foregoing embodiments, the hot sheet and said cold sheet terminate in a nozzle with a two-dimensional non-axisymmetric nozzle.

In a further embodiment of any of the foregoing embodiments, the multiple of stiffeners are non-uniformly distributed between said hot sheet and said cold sheet.

In a further embodiment of any of the foregoing embodiments, a first of said multiple of stiffeners defines a first spring rate and a second of said multiple of stiffeners defines a second spring rate, said first spring rate different than said second spring rate.

In a further embodiment of any of the foregoing embodiments, the first resilient member is brazed to said hot sheet and said second resilient member is brazed to said cold sheet.

In a further embodiment of any of the foregoing embodiments, the multiple of stiffeners provide thermal freedom between said hot sheet and said cold sheet.

In a further embodiment of any of the foregoing embodiments, the liner assembly includes a multiple of hangers attached to said hot sheet.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic view of an exemplary gas turbine engine for use with the present disclosure;

FIG. 2 is a lateral cross-section of an exhaust duct according to one non-limiting embodiment;

FIG. 3 is a lateral cross-section of an exhaust duct according to another non-limiting embodiment;

FIG. 4 is a lateral cross-section of an exhaust duct according to another non-limiting embodiment;

FIG. 5 is an exhaust duct according to another non-limiting embodiment;

FIG. 6 is an exhaust duct according to another non-limiting embodiment;

FIG. 7 is an expanded longitudinal cross-section-al view of a liner assembly with a multiple of stiffeners according to one disclosed non-limiting embodiment;

FIG. 8 is an expanded longitudinal perspective cross-section-al view of the liner assembly of FIG. 7;

FIG. 9 is an perspective view of a stiffener prior to formation;

FIG. 10 is a perspective view of a stiffener showing deflection in a radial direction;

FIG. 11 is a perspective view of a stiffener showing deflection in a longitudinal direction;

FIG. 12 is a perspective view of a stiffener showing deflection in a circumferential direction;

FIG. 13 is a lateral cross-section of a non-axisymmetric exhaust duct according to one non-limiting embodiment; and

FIG. 14 is a perspective partial phantom view of a liner assembly with an array of a multiple of stiffeners according to one disclosed non-limiting embodiment.

### DETAILED DESCRIPTION

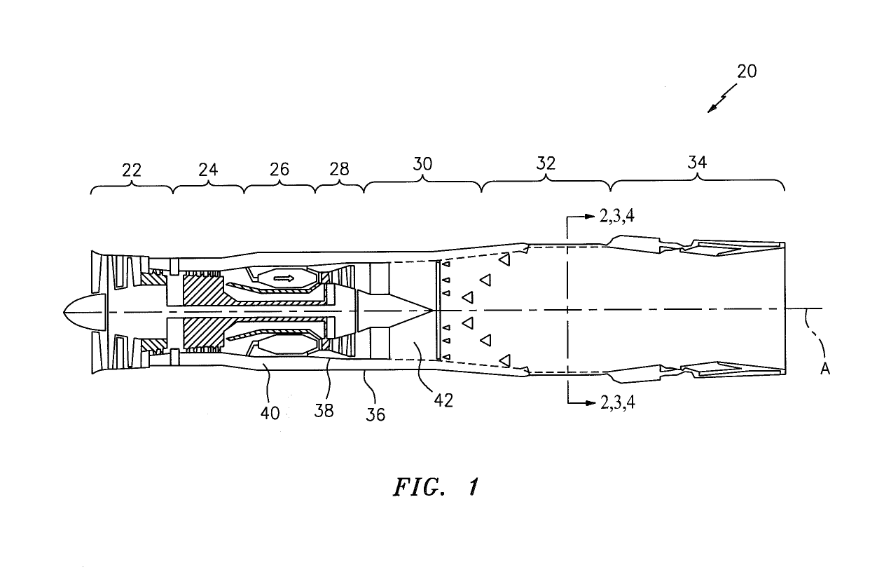

FIG. 1 schematically illustrates a gas turbine engine 20. The gas turbine engine 20 is disclosed herein as a two-spool low-bypass augmented turbofan that generally incorporates a fan 22, a compressor 24, a combustor 26, a turbine 28, an augmenter 30, an exhaust duct 32, and a nozzle 34 along a central longitudinal engine axis A. Although depicted as an augmented low bypass turbofan in the disclosed non-limiting embodiment, it should be understood that the concepts described herein are applicable to other gas turbine engines including geared architecture engines, direct drive turbofans, turbojet, turboshaft, three-stream variable cycle and other engine architectures.

An outer static structure 36 and an inner static structure 38 define a generally annular secondary airflow path 40 around a core primary airflow path 42. Various structure and modules may define the outer static structure 36 and the inner static structure 38 which essentially define an exoskeleton to support the core engine therein.

Air that enters the fan 22 is divided between a primary airflow through the primary airflow path 42 and a secondary airflow through the secondary airflow path 40. The core flow passes through the combustor 26, the turbine 28, then the augmentor 30 where fuel may be selectively injected and burned to generate additional thrust through the nozzle 34. It should be appreciated that additional airflow streams such as third stream airflow typical of variable cycle engine architectures may additionally be sourced from the fan 22.

The secondary airflow may be utilized for a multiple of purposes to include, for example, cooling and pressurization. The secondary airflow as defined herein is any airflow different from the primary combustion gas exhaust primary airflow. The secondary airflow may ultimately be at least partially injected into the primary airflow adjacent to the exhaust duct 32 and the nozzle 34.

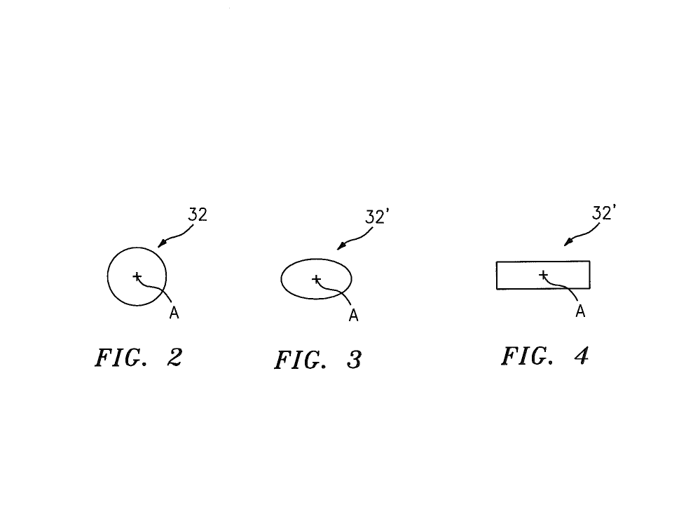

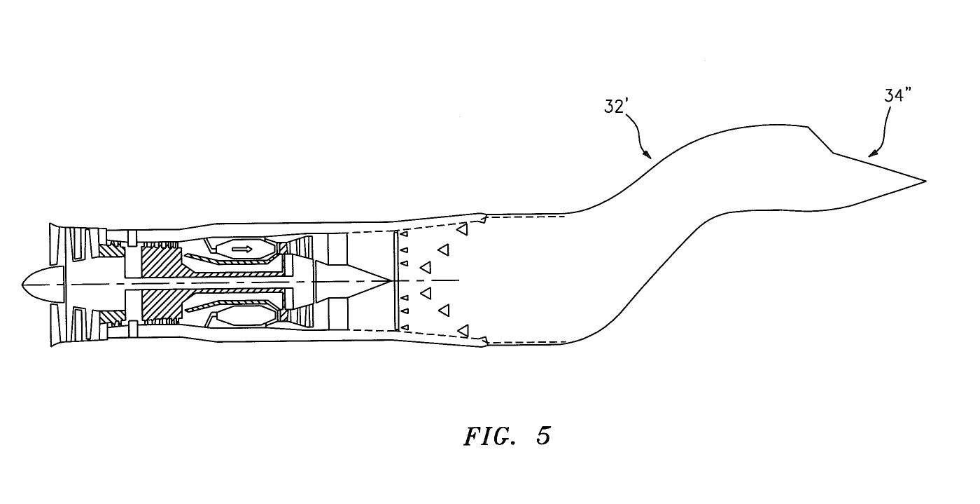

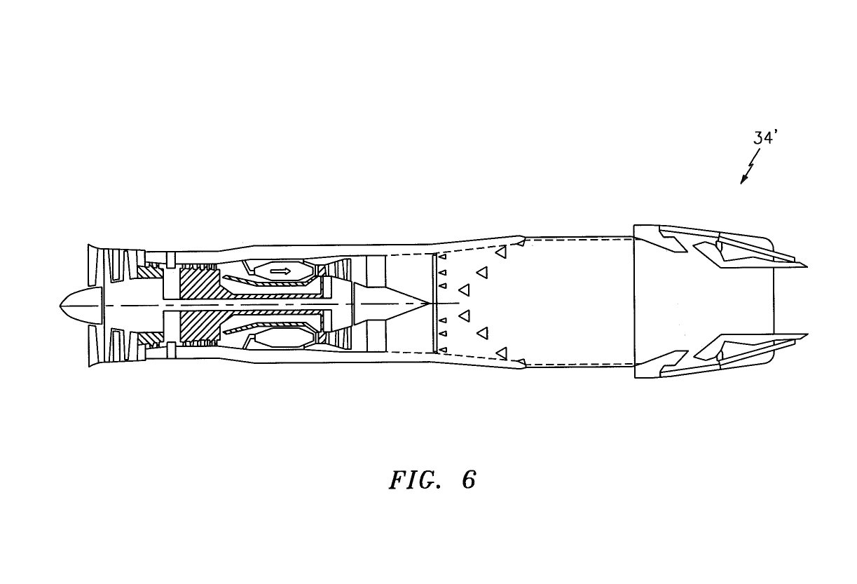

With reference to FIG. 2, the exhaust duct 32 may be circular in cross-section as typical of an axis-symmetric augmented low bypass turbofan. In another disclosed non-limiting embodiment the exhaust duct 32′ may be non-axisymmetric in cross-section—to include, but not be limited to, an oval cross-section—(FIG. 3) or a rectilinear cross-section—(FIG. 4). In addition to the various cross-section-s, the exhaust duct 32″ may be non-linear with respect to the central longitudinal engine axis A to form, for example, a serpentine shape to block direct view to the turbine 28 (FIG. 5). Furthermore, in addition to the various cross-section-s and the various longitudinal shapes, the exhaust duct 32 may terminate in a convergent divergent nozzle 34 (FIG. 1), a non-axisymmetric two-dimensional (2D) vectorable nozzle 34′ (FIG. 6), a flattened slot convergent nozzle of high aspect ratio 34″ (FIG. 5) or other exhaust arrangement.

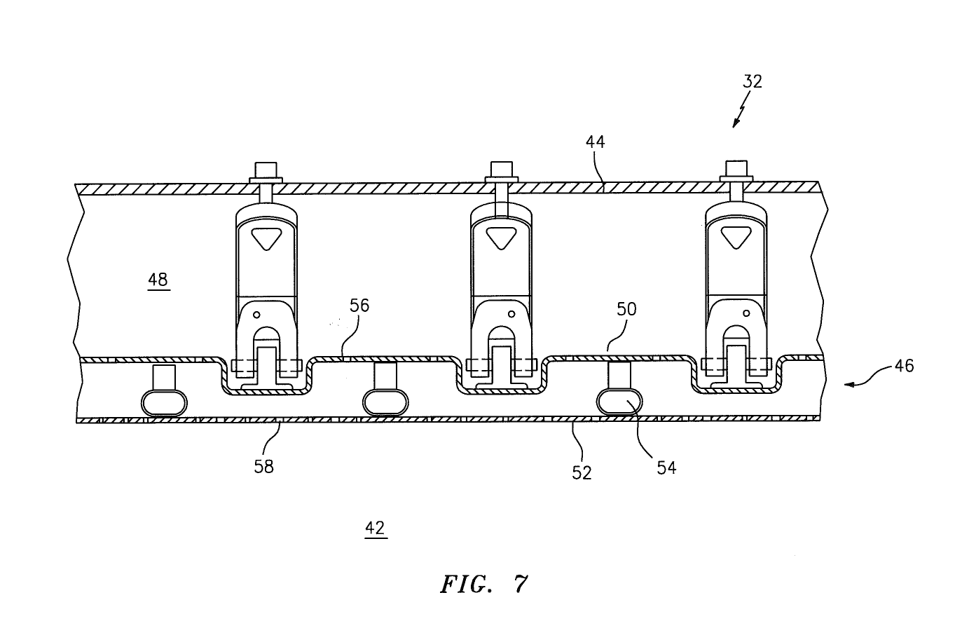

With reference to FIG. 7, the exhaust duct 32 generally includes an outer case 44 of the outer static structure 36 and a liner assembly 46 spaced inward therefrom. The liner assembly 46 operates as a heat shield to protect the outer case 44 from the extremely hot combustion gases in the primary airflow path 42. Air discharged from, for example, the fan 22 is communicated in an annular passageway 48 defined between the outer case 44 and the inner liner assembly 46. Since fan air and is relatively cool compared to the hot gases in the primary airflow path 42, the fan air cools the liner assembly 46 to enhance the life and reliability thereof.

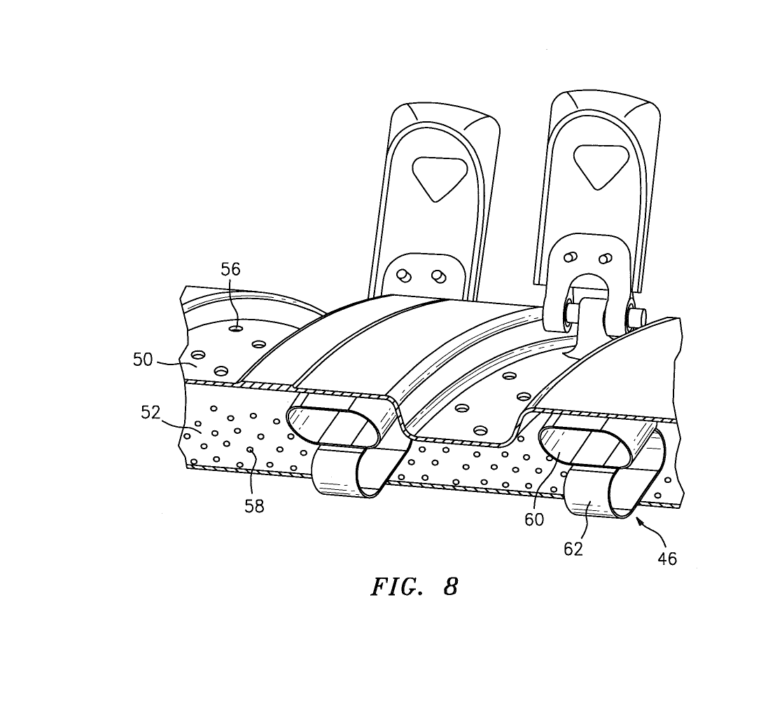

The liner assembly 46 generally includes a cold sheet 50 separated from a hot sheet 52 by a plurality of stiffeners 54 (also illustrated in FIG. 8). The cold sheet may be corrugated with various rippled or non-planar surfaces and include a multiple of metering holes 56 to receive secondary airflow from between the outer exhaust duct outer case 44 and the liner assembly 46. The secondary airflow is communicated through effusion holes 58 in the hot sheet 52. The effusion holes 58 are generally more prevalent and larger than the metering holes 56 such that the secondary airflow provides film cooling to sheath the liner assembly 46 with secondary airflow.

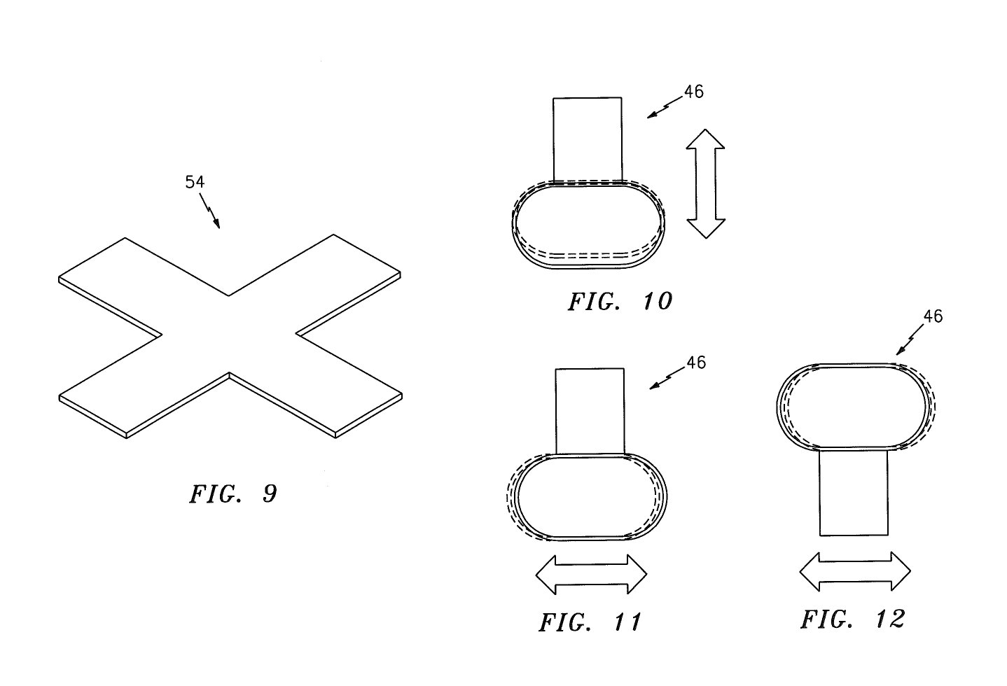

With reference to FIG. 8, each of the plurality of stiffeners 54 includes a first resilient member 60 arranged on a second resilient member 62. In one disclosed non-limiting embodiment, the first resilient member 60 is oriented substantially ninety (90) degrees to the second resilient member 62. Each stiffener may be manufactured from a cross-shaped stamped sheet metal detail (FIG. 9) that is formed into generally racetrack, oval, band, leaf or circular shapes then has the ends brazed together. That is, although illustrated in the disclosed non-limiting embodiment as a band, other shapes and configurations will benefit herefrom.

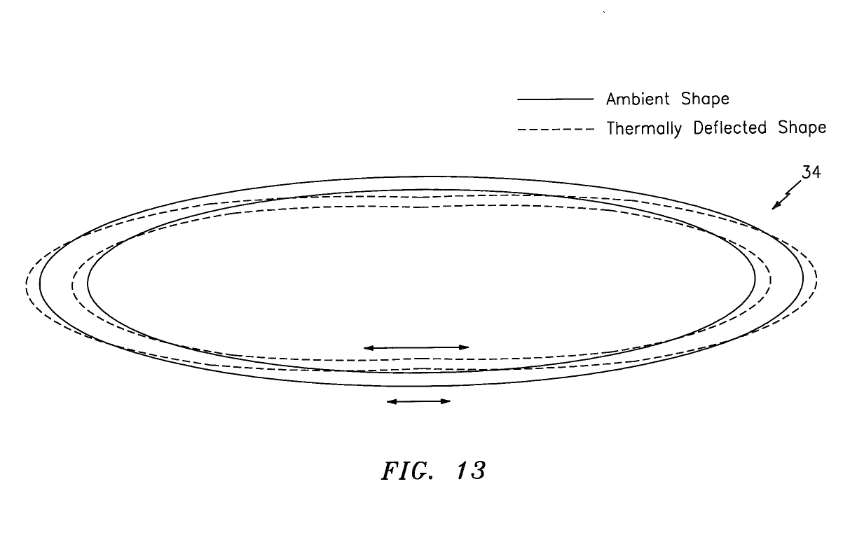

The first resilient member 60 is brazed to the cold sheet 50 and the second resilient member 62 is brazed to the hot sheet 52. It should be understood that other attachments such as welding, rivets or others will also benefit herefrom. The plurality of stiffeners 54 to provide thermal freedom between the cold sheet 50 and the hot sheet 52 in the radial, (FIG. 10), longitudinal (FIG. 11) and circumferential (FIG. 12) directions.

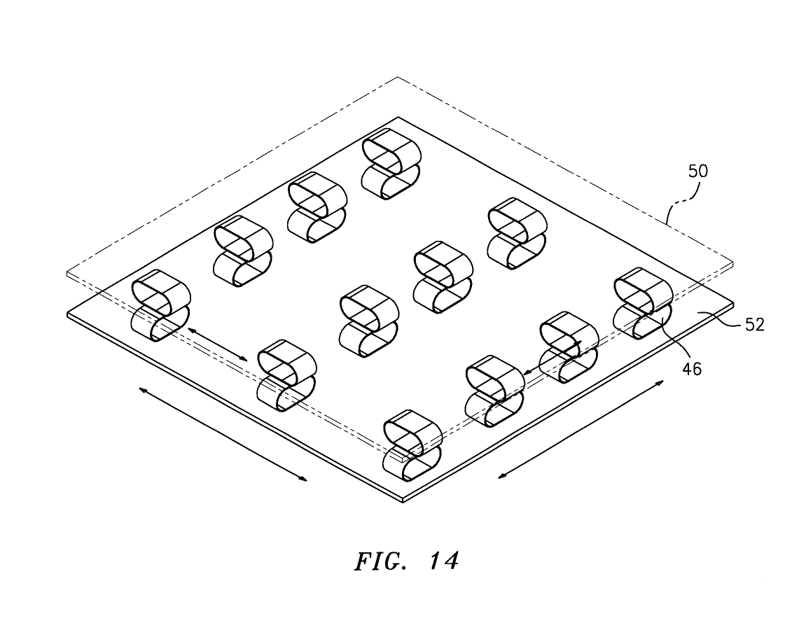

During engine operation, the cold sheet 50 receives relatively large pressure loads and deflections, while the hot sheet 52 receives relatively small pressure loads and deflections and thereby better retains heat resistant coatings. The plurality of stiffeners 54 provides stiffness to the liner assembly 46 yet operate as springs to accommodates movement through thermal deflections between the cold sheet 50 and the hot sheet 52. Non-axisymmetric exhaust duct s may be particularly susceptible to thermal deflection in the relatively flat regions (FIG. 13). That is, non-axisymmetric exhaust duct s areas will tend to elongate in cross-section along a major axis due to differential thermal growth.

The spring rate of the stiffeners 54 may be readily adjusted through, for example, material sheet thickness, height and width of the resilient members 60, 62. The spacing and array arrangement of the multiple of stiffeners 54 (FIG. 14) may also be varied to tailor the stiffness of the liner assembly 46 which, for example, may require less stiffen at the vertexes of the major axes, but more stiffness and the co-vertexes of the minor axis in non-axisymmetric exhaust duct s. It should be appreciated that various combinations will benefit particular exhaust duct cross-section-s and longitudinal shapes.

The multiple of stiffeners 54 thereby provide thermal compliance in all directions between the cold sheet 50 and the hot sheet 52 of the liner assembly irrespective of exhaust duct architecture. The thermal compliance also facilitates heat resistant coating retention on the hot sheet thereby reducing maintenance requirements. Moreover, the stiffeners 54 are relatively uncomplicated and inexpensive to manufacture compared to related art Z-resilient members.

It should be understood that like reference numerals identify corresponding or similar elements throughout the several drawings. It should also be understood that although a particular component arrangement is disclosed in the illustrated embodiment, other arrangements will benefit herefrom.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A stiffener for a liner assembly of a gas turbine engine comprising:
a first resilient member; and
a second resilient member arranged on said first resilient member at a substantially ninety (90) degree orientation.

2. The stiffener as recited in claim 1, wherein said first resilient member and said second resilient member are formed from a single cross-section-shaped piece.

3. The stiffener as recited in claim 1, wherein said first resilient member and said second resilient member are generally racetrack shaped.

4. The stiffener as recited in claim 1, wherein said first resilient member and said second resilient member are generally oval.

5. The stiffener as recited in claim 1, wherein said first resilient member and said second resilient member are generally circular.

6. A liner assembly for a gas turbine engine comprising:
a cold sheet;
a hot sheet; and
a multiple of stiffeners between said cold sheet and said hot sheet, at least one of said multiple of stiffeners includes a first resilient member arranged on a second resilient member.

7. The liner assembly as recited in claim 6, wherein said first resilient member and said second resilient member are oriented at a substantially ninety (90) degrees.

8. The liner assembly as recited in claim 6, wherein said cold sheet is corrugated.

9. The liner assembly as recited in claim 6, wherein said hot sheet and said cold sheet are axisymmetric in cross-section.

10. The liner assembly as recited in claim 6, wherein said hot sheet and said cold sheet are non-axisymmetric in cross-section.

11. The liner assembly as recited in claim 6, wherein said hot sheet and said cold sheet are oval in cross-section.

12. The liner assembly as recited in claim 6, wherein said hot sheet and said cold sheet are rectilinear in cross-section.

13. The liner assembly as recited in claim 6, wherein said hot sheet and said cold sheet define a serpentine duct.

14. The liner assembly as recited in claim 6, wherein said hot sheet and said cold sheet terminate in a nozzle with a convergent-divergent nozzle.

15. The liner assembly as recited in claim 6, wherein said hot sheet and said cold sheet terminate in a nozzle with a two-dimensional non-axisymmetric nozzle.

16. The liner assembly as recited in claim 6, wherein said multiple of stiffeners are non-uniformly distributed between said hot sheet and said cold sheet.

17. The liner assembly as recited in claim 6, wherein a first of said multiple of stiffeners defines a first spring rate and a second of said multiple of stiffeners defines a second spring rate, said first spring rate different than said second spring rate.

18. The liner assembly as recited in claim 6, wherein said first resilient member is brazed to said hot sheet and said second resilient member is brazed to said cold sheet.

19. The liner assembly as recited in claim 6, wherein said multiple of stiffeners provide thermal freedom between said hot sheet and said cold sheet.

20. The liner assembly as recited in claim 6, further comprising a multiple of hangers attached to said hot sheet.
